(19) United States
(12) Patent Application Publication
(10) Pub. No.: US 2010/0252749 A1
(43) Pub. Date: Oct. 7, 2010

(54) WIPER BLADE

(75) Inventors: Reiner Lay, Achen (DE); Marc Pironnet, Hakendover (Tienen) (BE); Wolfgang Endres, Tienen (BE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/160,471

(22) PCT Filed: Jan. 15, 2007
(86) PCT No.: PCT/EP07/50351

§ 371 Date: Jul. 10, 2008

(30) Foreign Application Priority Data
Mar. 2, 2006 (DE) 102006009653.3

(51) Int. Cl. G01T 1/10; C10M 161/00; C10M 169/04

(52) U.S. Cl. 250/459.1; 508/162; 508/165; 508/308; 508/266; 508/246; 508/117; 508/122; 508/178; 508/179; 508/168; 508/169; 508/167

(57) ABSTRACT

The invention describes a wiper blade, in particular for windscreen wipers, which is at least partly provided with at least one coating, wherein the coating contains at least one indicator component for determining the layer thickness of the coating. The invention also describes a method for determining the layer thickness of a coasting of a wiper blade.

### BACKGROUND OF THE INVENTION

The invention relates to a wiper blade, in particular for windscreen wipers of a motor vehicle, and a method for determining the layer thickness of a coating of a wiper blade.

In order that windscreen wiper blades adapt as well as possible to the contour of the pane of the motor vehicle and are also flexible at different temperatures, wiper blades are produced as a rule from elastomer profiles, substantially rubber materials, such as natural rubber or synthetic rubber, such as, for example chloroprene rubber, silicone rubber or polyurethane rubber.

Compared with materials such as glass or plastic, elastomers have high coefficients of sliding friction so that, at a fixed applied vertical force of an elastomer profile in the form of a windscreen wiper blade on the surface of a glass pane, a multiple of the applied force frequently has to be expended for a horizontal movement. If the windscreen wiper is operated under wet conditions, this presents no substantial problem since a thin lubricating film between the windscreen wiper blade and the pane is formed by the water film on the pane so that hydrodynamic lubrication occurs. However, problems occur if the windscreen wiper blade is operated without water as a lubricating film, for example in summer or after brief rain showers. Under such conditions, rapid drying of the pane takes place, with the result that the coefficient of friction increases greatly, which may lead to squeaking, juddering or even stoppage of the windscreen wiper.

In order to reduce the coefficient of friction of windscreen wiper blades relative to a dry glass pane, chlorination or bromination of the surface of the windscreen wiper blade, i.e. curing, is frequently carried out. However, this requires very exact process management and is not without problems from environmental points of view. Moreover, the wiping quality may be adversely affected by such treatment methods.

Furthermore, it has already been proposed to provide elastomer profiles with a coating which in particular reduces the coefficient of friction under dry conditions, i.e. the coefficient of dry friction. Thus, for example, coating a wiper lip with a silicone rubber in which molybdenum disulfide has been introduced as dry lubricant for reducing the coefficient of friction is known. The use of a polyurethane coat as a binder into which graphite powder has been incorporated is also known. In addition, a one-component polyurethane coat which contains reactive polysiloxanes is known for the coating of elastomers. Furthermore, a coating which also contains an additive, such as carbon black, Teflon, graphite or talc, in addition to a polyurethane and a siloxane is known. Coatings which have a low coefficient of friction under dry conditions can be produced on elastomers with this material.

Since, owing to their black or black-gray color, the known friction-reducing coatings cannot be distinguished from the elastomer profile of the wiper blade, it has not been possible to date to check the quality of the coating visually. Defects in the coating of a wiper blade, for example regions without coating or with too little coating, therefore cannot be unambiguously detected. The checking of the coating with regard to its distribution over the wiper blade is additionally complicated in that the known friction-reducing coatings and the elastomer profile of the wiper blade are chemically very similar since they mainly comprise the chemical elements carbon and hydrogen.

U.S. Pat. No. 5,349,718 has already disclosed the provision of a wiper blade with a coating which gradually changes its color during the use of the wiper blade under the action of the atmospheric UV radiation. The gradual color change is intended to indicate the life of the wiper blade and to indicate to the user of the wiper blade the necessity of changing the wiper blade.

Such a coating is not suitable for detecting defects in the coating, e.g. of an antifriction lacquer, since it is applied as a separate layer to the wiper blade and moreover the color change takes place only gradually.

### SUMMARY OF THE INVENTION

The wiper blade according to the invention has the advantage that the layer thickness of the coating of the wiper blade can be determined. This takes place by virtue of the fact that the wiper blade at least partly has at least one coating which contains at least one indicator component for determining the layer thickness of the coating. The coating is in particular a friction-reducing coating, preferably an antifriction lacquer coating. In the context of the present invention, an indicator component is understood as meaning a component whose proportion in the coating is substantially less than all other components of the coating. The proportion of the indicator component is preferably not more than 3% by weight, particularly preferably from 0.1 to 2.0% by weight. Furthermore, an indicator component is understood as meaning that it has no influence but at most a negligible influence on the tribological, physical, chemical and other properties of the coating. In particular, the indicator component is chemically inert to the coating and to the wiper blade. Finally, in the context of the present invention, an indicator component is distinguished in that its proportion, based on the coating, and hence the layer thickness of the coating can be measured by an nondestructive method.

The invention is based on the idea that an additional component which serves as an indicator for the layer thickness of the coating is added in a small amount to a coating of a wiper blade. Because the indicator component is distributed substantially homogeneously in the coating, the proportion of the component in the coating is proportional to the layer thickness thereof. By determining the proportion of the indicator component, the layer thickness can therefore be determined.

The invention makes it possible to detect defects in the coating, such as uncoated regions or regions with too small a layer thickness or with flaked-off coating, of a wiper blade. With the aid of the indicator component, the wear of the coating through the use of the wiper blade can also be investigated.

The production of the coating which contains an indicator component can be effected by a method which is the same as or similar to that for the production of the coating without an indicator component. The application of the coating to the wiper blade can also be effected by a method which is the same as or similar to that for the application of a coating without indicator component. Herein lies a further advantage of the wiper blade according to the invention, since the process for the production of the coating and the process for application of the coating need not be changed. All that is required is that an indicator component be added to the coating during its production.

Since the proportion of the indicator component to be measured in particular by a nondestructive method, the wiper blade can be put to its usual use in a windscreen wiper unit, for example of a motor vehicle, without impairing the wiping quality after determination of the layer thickness of the coating. This has the advantage that the determination of the layer thickness can be carried out not only in the form of random tests on individual wiper blades but on a relatively large number of wiper blades. The determination of the layer thickness could possibly be effected for each individual wiper blade. Thus, the quality of the coating can be monitored, for example continuously, during the production process.

In a preferred embodiment, the indicator component is a fluorescent component, in particular a UV fluorescent component, or a mixture of different fluorescent components. Other indicator components or marker components for the layer thickness are also possible. Thus, for example, it will be possible to use a weakly radioactive component whose radiation is proportional to the amount present in the coating. It would also be possible to use radiation-free carbon isotopes, such as, for example, C13, as an indicator component, which can be detected by means of C13-NMR. However, a fluorescent indicator component has the advantage that not only is the indicator component itself relatively advantageous but its method of determination, UV spectroscopy, can also be carried out relatively advantageously and with little effort.

The fluorescent component may be an inorganic or organic compound. It may be present in solid form, i.e. as a pigment, or in liquid form, i.e. as a dye. The fluorescent component may be, for example, an autunite, oxazine, rhodamine, carbocyanine, uranin or fluorescein.

If the coating contains a fluorescent component as an indicator component for the layer thickness, the coating of the wiper blade is irradiated with ultraviolet radiation by means of an ultraviolet (UV) radiation source for determining the layer thickness. The fluorescent component absorbs the ultraviolet radiation and emits a characteristic yellow-green light. The intensity of the emitted fluorescence can be measured, for example, by means of a UV spectrometer and can be quantified, the intensity of the fluorescence being proportional to the amount of the fluorescent component and hence the layer thickness.

Accordingly, the invention furthermore relates to a method for determining the layer thickness of a coating of a wiper blade having the features of the independent claim.

The method according to the invention for determining the layer thickness of a coating of a wiper blade comprises the following steps:

(a) at least partial coating of a wiper blade with a coating which contains at least one fluorescent component

(b) irradiation of the coating of the wiper blade coated according to step (a) by means of an ultraviolet radiation source

(c) measurement of the intensity of the fluorescence emitted on irradiation according to step (b)

(d) determination of the layer thickness of the coating with the aid of the fluorescence intensity measured according to step (c).

The coating of the elastomer profile of a wiper blade (step (a)) is effective, for example, by means of spraying, spreading or the like. After application, the coating is dried, if appropriate with heating.

The irradiation of the coating according to step (b)) of the method according to the invention can be effected by means of a conventional UV radiation source and with the usual intensity as used for the detection of the fluorescent components.

The measurement of the intensity of the fluorescence which is emitted on irradiation can be carried out using a conventional UV spectrometer (step (c)).

The determination of the layer thickness of the coating with the aid of the fluorescence intensity measured according to step (c) is subject to the known laws according to which the proportion of the fluorescent component, and hence the layer thickness, proportional to the fluorescence intensity.

The coating of the wiper blade according to the invention is in particular a friction-reducing coating, preferably an antifriction lacquer. The friction-reducing coating can be applied directly to the wiper blade or may be provided as one of a plurality of different coatings. It can furthermore be applied in one or more layers. The layer thickness of the friction-reducing coating is preferably in the range from 2 to 20 μm.

The antifriction lacquer contains at least one dry lubricant, in particular graphite, polytetrafluoroethylene, poly-propylene, polyethylene or molybdenum disulfide, a binder, in particular polyacrylate, polyurethane or melamine resin, and a solvent, in particular water and/or one or more organic solvents.

The antifriction lacquer is in particular a polyurethane system to which, if appropriate, a second, reactive component containing isocyanate groups is added. The isocyanate groups of the second component produce subsequent chemical crosslinking of the binder so that they form a constituent which reduces the coefficient of friction and is integrated into the polymer. The antifriction lacquer is preferably present as an aqueous one-component lacquer or as a two-component lacquer.

Graphite is particularly suitable as the dry lubricant. Furthermore, the addition of polypropylene powder or of pulverulent polytetrafluoroethylene or molybdenum disulfide is advantageous. Furthermore, two or more of said dry lubricants may also be added to the antifriction lacquer, possibly also in combination with a polyamide powder, polyethylene powder and/or a solution of a polyamide. Mixtures of graphite with a further dry lubricant have proven particularly advantageous. Thus, in particular graphite in combination with polytetrafluoroethylene, polyamide, polypropylene, polyethylene or molybdenum disulfide is suitable. Such modified antifriction lacquers lead to very readily adhering coatings on wiper blades with particularly low coefficients of dry friction of not more than 1.5, in some cases below 1.0, which coatings are simultaneously abrasion-resistant and resistant to weathering.

The dry lubricant provided in the antifriction lacquer preferably has a particle size of not more than 20 μm, ideally less than 10 μm. Substantially streak-free wiping behavior of the wiper blade is ensured.

The antifriction lacquer comprising a polyurethane, if appropriate a curing agent and the graphite powder added as a dry lubricant is applied in the form of a thin coating to the elastomer profile and dried for 10 min at a temperature of 120° C.

A suitable antifriction lacquer is, for example, an antifriction lacquer as described in WO 03/106575 A.

The fluorescent component has no adverse effect on the function of the antifriction lacquer, such as adhesion, coefficient of friction and reduction of coefficient of friction and on the wear behavior.

### WORKING EXAMPLE

Suitable antifriction lacquer systems consist of about 10% by weight of fine graphite, about 4-8% by weight of an aqueous binder dispersion (e.g. polyacrylate or polyurethane), about 10-15% by weight of organic solvent (e.g. butoxyethanol), about 0.5% by weight of the indicator component (uranin AP or fluorescein) and about 70% by weight of water. The antifriction lacquer is prepared in a suitable dissolver with moderate stirring.

The antifriction lacquer coating was irradiated by means of a UV lamp of wavelength 254 nm and 360 nm. The wavelength 254 nm is particularly suitable since the fluorescence is particularly strongly distinguished from an uncoated substrate (wiper blade) or one which is coated to a lesser extent.

The fluorescence was measured with the aid of a commercially available UV spectrometer in reflection and was quantified. The layer thickness was determined therefrom according to the known laws.

1. A wiper blade at least partly provided with at least one coating, characterized in that the coating contains at least one indicator component for determining the layer thickness of the coating.

2. The wiper blade as claimed in claim 1, characterized in that the proportion of the indicator component in the coating can be measured by a nondestructive method.

3. The wiper blade as claimed in claim 1, characterized in that the proportion of the indicator component, based on the coating, is not more than 3% by weight, preferably from 0.1 to 2.0% by weight.

4. The wiper blade as claimed in claim 1, characterized in that the indicator component is a UV-fluorescent component.

5. The wiper blade as claimed in claim 4, characterized in that the fluorescent component is an inorganic or organic compound.

6. The wiper blade as claimed in claim 4, characterized in that the fluorescent component is an autunite, oxazine, rhodamine, carbocyanine, uranin or fluorescein.

7. The wiper blade as claimed in claim 1, characterized in that the coating is an antifriction lacquer.

8. The wiper blade as claimed in claim 7, characterized in that the antifriction lacquer contains at least one dry lubricant, in particular graphite, polytetrafluoroethylene, polypropylene, polyethylene or molybdenum disulfide.

9. The wiper blade as claimed in claim 7, characterized in that the antifriction lacquer contains a binder, in particular polyacrylate, polyurethane or melanine resin.

10. A method for determining the layer thickness of a coating of a wiper blade, comprising the following steps:
(a) at least partial coating of a wiper blade with a coating which contains at least one fluorescent component;
(b) irradiation of the coating of the wiper blade coated according to step (a) by means of an ultraviolet radiation source;
(c) measurement of the intensity of the fluorescence emitted on irradiation according to step (b); and
(d) determination of the layer thickness of the coating with the aid of the fluorescence intensity measured according to step (c).

11. The wiper blade as claimed in claim 2, characterized in that the proportion of the indicator component, based on the coating, is not more than 3% by weight, preferably from 0.1 to 2.0% by weight.

12. The wiper blade as claimed in claim 11, characterized in that the indicator component is a UV-fluorescent component.

13. The wiper blade as claimed in claim 12, characterized in that the fluorescent component is an inorganic or organic compound.

14. The wiper blade as claimed in claim 13, characterized in that the fluorescent component is an autunite, oxazine, rhodamine, carbocyanine, uranin or fluorescein.

15. The wiper blade as claimed in claim 14, characterized in that the coating is an antifriction lacquer.

16. The wiper blade as claimed in claim 15, characterized in that the antifriction lacquer contains at least one dry lubricant, in particular graphite, polytetrafluoroethylene, polypropylene, polyethylene or molybdenum disulfide.

17. The wiper blade as claimed in claim 16, characterized in that the antifriction lacquer contains a binder, in particular polyacrylate, polyurethane or melanine resin.
